(19) United States
(12) Patent Application Publication
(10) Pub. No.: US 2009/0047109 A1
(43) Pub. Date: Feb. 19, 2009

(54) TRANSFER WHEEL DEVICE FOR A SLICER

(76) Inventor: Tien-Fu YEH, AN-DING HSIANG (TW)

Correspondence Address: PATENTTM.US, P. O. BOX 82788, PORTLAND, OR, 97282-0788, US

(21) Appl. No.: 11/838,018

(22) Filed: Aug. 13, 2007

(51) Int. Cl. B65G 29/00; B65G 39/02

(52) U.S. Cl. 414/433; 198/803.16

(57) ABSTRACT

A transfer wheel device for a slicer has a rolling pipe and an inner pipe. The rolling pipe is rotatably connected to the slicer and has multiple inlet holes formed trough an external surface of the rolling pipe. The inner pipe is rotatably mounted in the rolling pipe and securely on the slicer and has a linear suction array. The linear suction array is formed linearly on an external surface of the inner pipe and has multiple suction units. Each suction unit has a suction hole formed through the inner pipe to increase ease and effectiveness of the transfer wheel device.

### BACKGROUND OF THE INVENTION

1. Field of the Invention

The present invention relates to a transfer wheel device, and more particularly to a transfer wheel device for a slicer that can transfer slices easily, certainly and separate the slice effectively from a working piece.

2. Description of Related Art

With reference to FIG. 8A, a conventional slicer is used to process with rubbers and comprises a body, a conveyor (92), a cutter (93) and a rolling pipe (94). The body has a sidewall and a drive device. The conveyor (92) is mounted adjacent to the body and has multiple rollers (922) and a belt (921). The belt (921) is driven by the rollers (922) to transfer a working piece (81). The cutter (93) is connected to the sidewall of the body adjacent to the conveyor (92), separated by a pre-calculated distance from the belt (921) to form an outlet (95) between the belt (921) and the cutter (93). With reference to FIG. 8B, the cutter (93) is used to cut a slice from a working piece (81) to form a thin slice (811) when the working piece (81) is moved through the cutter (93) by the conveyor (92).

With further reference to FIGS. 6 and 7, the rolling pipe (94) is rotatably connected to the sidewall of the body adjacent to the cutter (93) and has an external surface, a proximal end, a distal end and multiple inlet holes (941). The proximal end of the rolling pipe (94) is connected to the drive device and rotates relative to the cutter (93). The inlet holes (941) are formed uniformly through the external surface of the rolling pipe (94). The distal end of the rolling pipe (94) is connected to an exhaust fan. The exhaust fan is used to extract air from the rolling pipe (94) to form suction and allow the rolling pipe (94) to attract the slice (811) cut from the working piece (81) to clear space for the cutter (93) to increase lifespan of the cutter (93) and improve a finish of the working piece (81).

However, the inlet holes (941) are uniformly formed through the external surface of the rolling pipe (94) and air may flow into the rolling pipe (94) from the inlet holes (941) that do not correspond to the slice (811), thereby reducing suction strength of the rolling pipe (94).

### SUMMARY OF THE INVENTION

The main objective of the present invention is to provide a transfer wheel device for a slicer that can transport slices easily, certainly and separate the slice effectively from a working piece.

The transfer wheel device for a slicer has a rolling pipe and an inner pipe. The rolling pipe is rotatably connected to the slicer and has multiple inlet holes formed trough an external surface of the rolling pipe. The inner pipe is rotatably mounted in the rolling pipe and securely on the slicer and has a linear suction array. The linear suction array is formed linearly on an external surface of the inner pipe and has multiple suction units. Each suction unit has a suction hole formed through the inner pipe to increase ease and effectiveness of the transfer wheel device.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a transfer wheel device in accordance with the present invention;

FIG. 2 is cross section side view of the transfer wheel device in FIG. 1;

FIG. 3A is a side view of the transfer wheel device in FIG. 1 mounted on a slicer;

FIG. 3B is an operational side view of the transfer wheel device in FIG. 1 mounted on a slicer, shown with a working piece;

FIGS. 4A to 4D are enlarged operational side views of the transfer wheel device in FIG. 3B, shown sucking and transferring the working piece;

FIG. 5 is an operational side view the transfer wheel in FIG. 1, mounted on a second embodiment of a slicer;

FIG. 6 is a perspective view of a rolling pipe in accordance with the prior art;

FIG. 7 is a cross section side view of the rolling pipe in FIG. 6;

FIG. 8A is a side view of the rolling pipe in FIG. 6 mounted on a slicer; and

FIG. 8B is an operational side view of the rolling pipe in FIG. 6 mounted on a slicer, shown with a working piece.

### DETAILED DESCRIPTION OF THE PREFERRED EMBODIMENT

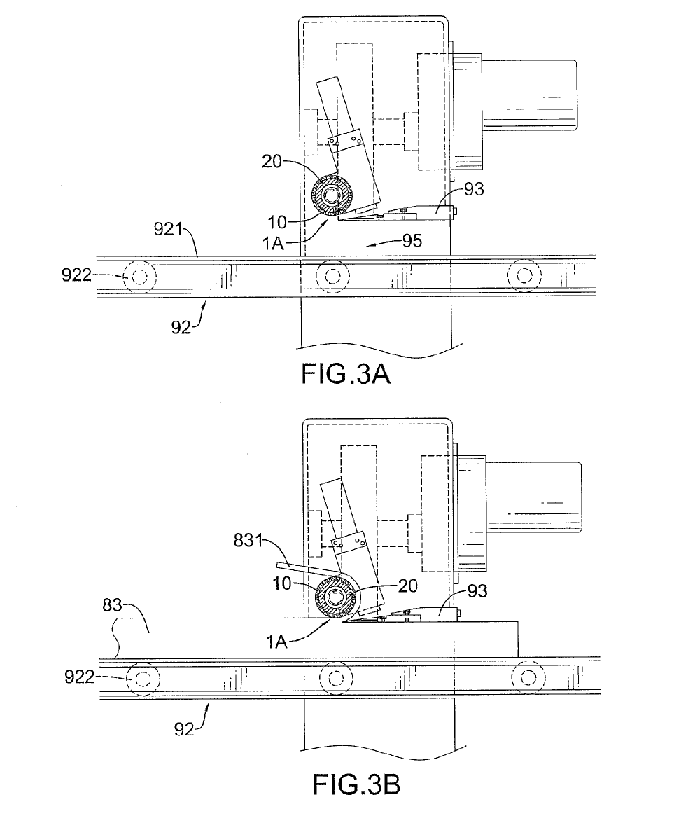

With reference to FIGS. 3 A and 3B, a slicer comprises a body, a conveyor (92), a cutter (93) and at least one transfer wheel device (1A). The body has a sidewall and a drive device. The conveyor (92) is mounted adjacent to the body and has multiple rollers (922) and a belt (921). The belt (921) is driven by the rollers (922) to transfer a working piece (83). The cutter (93) is connected to the sidewall of the body over the conveyor (92) at a pre-calculated height relative to the belt (921) to form an outlet (95) between the belt (921) and the cutter (93). The cutter (93) is used to cut a segment of a working piece (83) to form a thin slice (831) when the working piece (83) is transported below the cutter (93) by the conveyor (92).

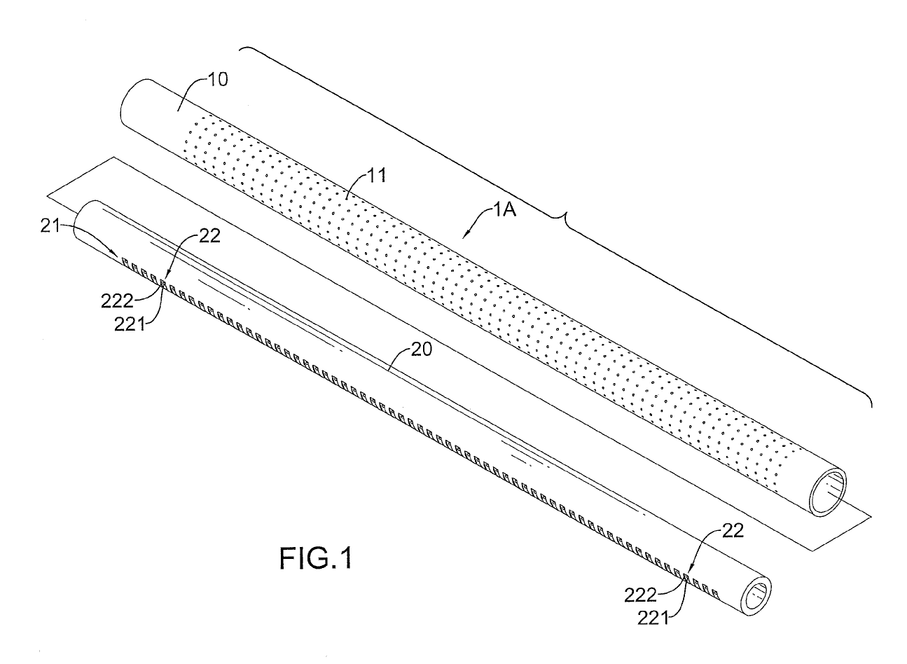

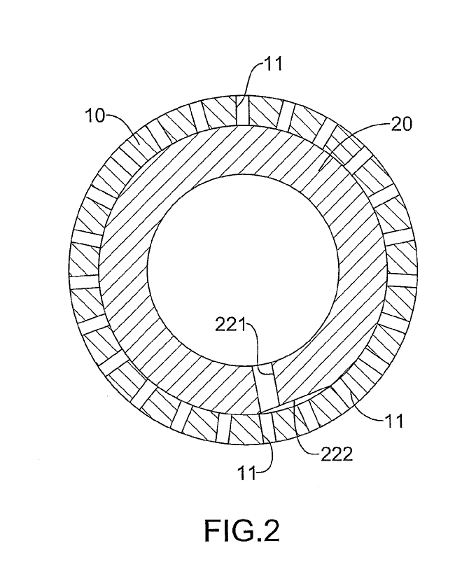

With reference to FIGS. 1 and 2, the transfer wheel device (1A) is rotatably connected to the sidewall of the body, adjacent to the cutter (93) and has a rolling pipe (10) and an inner pipe (20).

The rolling pipe (10) is rotatably connected to the sidewall of the body adjacent to the cutter (93) and has an external surface and multiple inlet holes (11). The inlet holes (11) are formed uniformly through the external surface of the rolling pipe (10).

The inner pipe (20) is rotatably mounted in the rolling pipe (10) and securely to the sidewall of the body, has an interior, an external surface, a distal end and a linear suction array (21). The distal end is connected to an exhaust fan to form a vacuum inside the inner pipe (20). The linear suction array (21) is formed linearly through the external surface of the inner pipe (20) and mounted facing the outlet (95) and has multiple suction units (22). The suction units (22) are formed on the linear suction array (21) and each suction unit (22) has a suction hole (221) and may further have an optional tangent plane (222). The suction holes (221) are formed through the external surface of the inner pipe (20), communicate with the interior of the inner pipe (20) and are defined along the linear suction array (21). Each tangent plane (222) is formed at a tangent from each suction hole (221) on the external surface of the inner pipe (20).

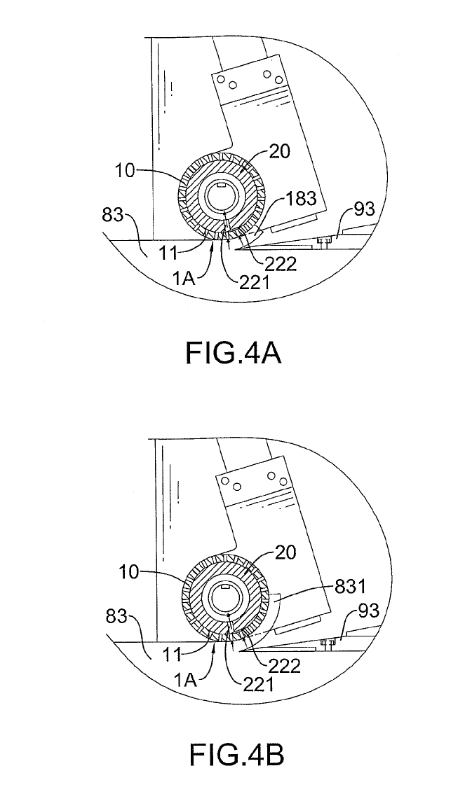

With reference to FIGS. 3B and 4A to 4D, the rolling pipe (10) rotates relative to the inner pipe (20) to suck the slice (831) from the working piece (83) only when the inlet holes (11) aligned with and communicate with the suction holes (221) of the inner pipe (20). Therefore, the inner pipe (20) has greater suction strength focused on the inlet holes (11) adjacent to the cuter (93) so the slice (831) can be sucked onto the external surface of the rolling pipe (10) easily, securely and separated from the working piece (83) effectively. In addition, the tangent plane (222) allows at least two inlet holes (11) to communicate with each corresponding suction hole (221) to increase a suction area of the transfer wheel device (1A).

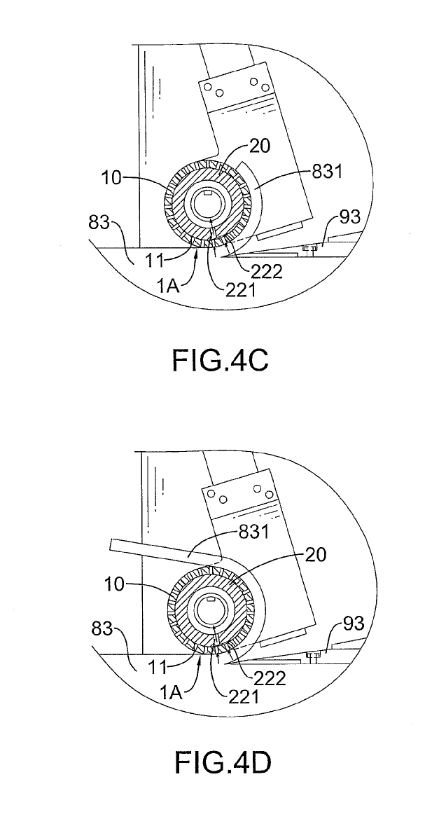

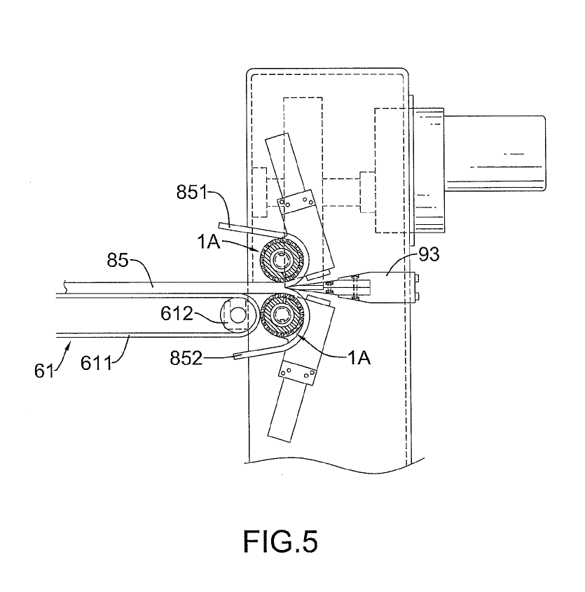

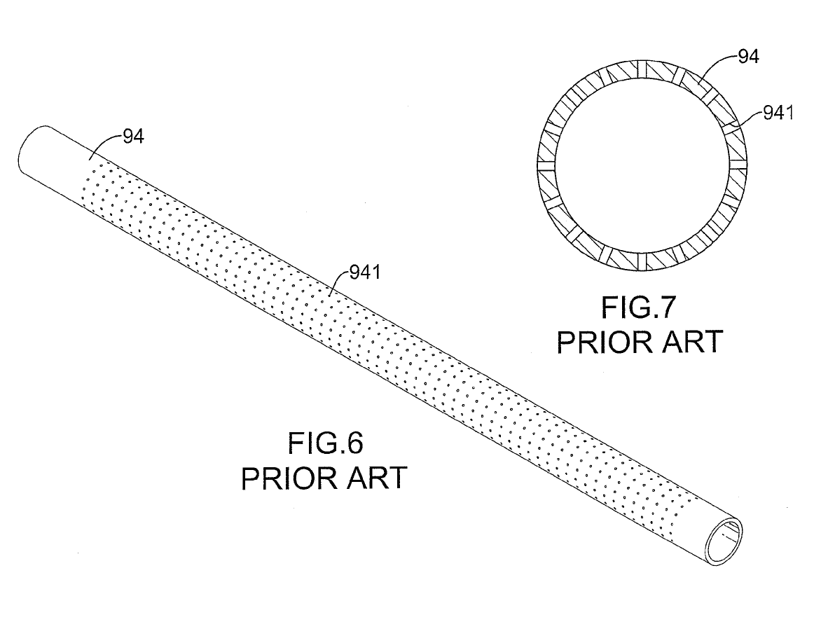

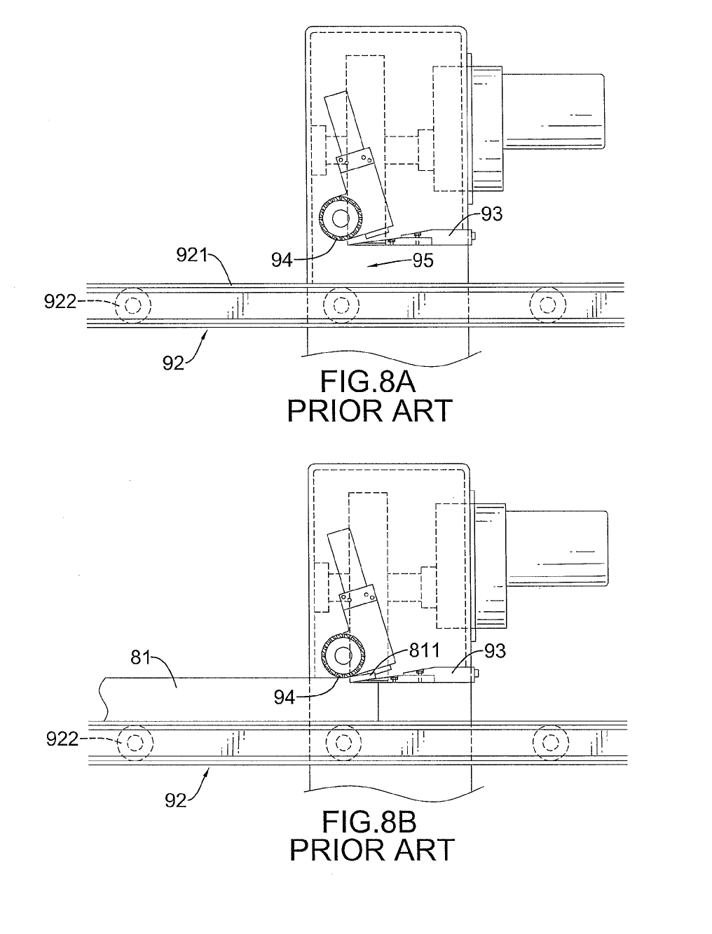

With reference to FIG. 5, another slicer comprises a body, a conveyor (61) with multiple rollers (612) and a belt (611), a cutter (93), two transfer wheel devices (1A) and the predetermined height of the cutter (93) is zero. The transfer wheels (1A) are further mounted respectively above and below the cutter (93). Therefore, the cutter (93) splits a working piece (85) into two slices (851, 852) that are attracted respectively to the corresponding transfer wheel device (1A) and separated from the working piece (85).

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A transfer wheel device for a slicer comprising
a rolling pipe adapted for being rotatably connected to the slicer and having an external surface; and
multiple inlet holes being formed uniformly through the external surface of the rolling pipe; and
an inner pipe being rotatably mounted in the rolling pipe and adapted for being securely connected to the slicer and having
an interior;
an external surface; and
a linear suction array being formed linearly through the external surface of the inner pipe and having
multiple suction units being formed on the linear suction array and each suction unit having
a suction hole being formed through the external surface of the inner pipe, communicating with the interior of the inner pipe and being defined along the linear suction array.

2. The transfer wheel device as claimed in claim 1, wherein each suction unit further has a tangent plane formed from the suction hole on the external surface of the inner pipe.
